(19) United States
(12) Patent Application Publication
(10) Pub. No.: US 2017/0175512 A1
(43) Pub. Date: Jun. 22, 2017

(54) HIGH AMPLITUDE MAGNETIC CORE

(71) Applicant: Schlumberger Technology Corporation, Sugar Land, TX (US)

(72) Inventors: Jean-baptiste Cozon, Clamart (FR); Martin David, Clamart (FR); Pierre Mouget, Clamart (FR)

(21) Appl. No.: 15/354,180

(22) Filed: Nov. 17, 2016

(30) Foreign Application Priority Data
Dec. 17, 2015 (EP) 15290322.5

(51) Int. Cl. E21B 47/00; G01B 7/06

(52) U.S. Cl. CPC E21B 47/00; G01B 7/10

(57) ABSTRACT

A magnetic core having an inner core and one or more bundles of stacked magnetic strips arranged over the length of the inner core generates an increased magnetic field with limited saturation. The magnetic strips may include silicon-iron, iron cobalt, or combinations thereof. A method of manufacturing the core includes providing a plurality of magnetic strips each having a length longer than a width, coupling the plurality of magnetic strips along one length of each of the plurality of magnetic strips, and shaping the plurality of magnetic strips partially or fully around an inner circumference.

### CROSS-REFERENCE TO RELATED APPLICATIONS

The present invention claims the benefits of European Patent Application No. 15290322.5, filed on Dec. 17, 2015, titled “HIGH AMPLITUDE MAGNETIC CORE,” the entire content of which is hereby incorporated by reference into the current application.

### BACKGROUND

The present disclosure relates generally to improving data logging quality of electromagnetic downhole logging tools.

This section is intended to introduce the reader to various aspects of art that may be related to various aspects of the present techniques, which are described and/or claimed below. This discussion is believed to be help provide the reader with background information to facilitate a better understanding of the various aspects of the present disclosure. Accordingly, it should be understood that these statements are to be read in this light, and not as an admission.

In well-logging via electromagnetic field testing, an electromagnetic logging tool is inserted into an interior diameter of a conductive tubular or casing joint (“casing”). A transmitter of the electromagnetic logging tool creates an electromagnetic field that interacts with the casing and varies depending on a metal thickness of the casing. One or more receivers of the electromagnetic logging tool may be used to measure and generate a data log illustrating variations in one or more resulting and returning electromagnetic fields. The metal thickness of the casing may be determined by analyzing the detected variations in the data log. An area of the casing that is determined to have less metal thickness may indicate a defect in the casing (e.g., due to corrosion). However, due to current trends of larger, thicker casings, the electromagnetic logging tool should also be able to generate an electromagnetic field capable of interacting with larger, thicker casings.

### SUMMARY

Various refinements of the features noted above may exist in relation to various aspects of the present disclosure. Further features may also be incorporated in these various aspects as well. These refinements and additional features may exist individually or in any combination. For instance, various features discussed below in relation to one or more of the illustrated embodiments may be incorporated into any of the above-described aspects of the present disclosure alone or in any combination. Again, the brief summary presented above is intended only to familiarize the reader with certain aspects and contexts of embodiments of the present disclosure without limitation to the claimed subject matter.

In a first embodiment, a system includes a plurality of nested casings disposed in a wellbore. The system also includes an electromagnetic logging tool disposed in one or more casings. The electromagnetic logging tool includes a magnetic core having an inner core and one or more bundles of stacked magnetic strips arranged over the length of the inner core generates an increased magnetic field with limited saturation. The magnetic strips may include silicon-iron, iron cobalt, or combinations thereof. A method of manufacturing the core includes providing a plurality of magnetic strips each having a length longer than a width, coupling the plurality of magnetic strips along one length of each of the plurality of magnetic strips, and shaping the plurality of magnetic strips partially or fully around an inner circumference.

In one or more embodiments, an apparatus for measuring casing thickness includes a magnetic core having an inner core having a core length and one or more bundles comprising stacked magnetic strips arranged over the core length of the inner core. The magnetic core may further include an external layer substantially surrounding the one or more bundles. The one or more bundles may include a bundle of silicon-iron strips coupled together on one side and flexibly formed over the inner core. The one or more bundles may include a first bundle formed over and around the inner core and a second bundle formed over and around the first bundle.

In one or more embodiments, the one or more bundles includes two semi-cylindrical bundles each comprising the stacked magnetic strips, wherein the two semi-cylindrical bundles are configured to mate with one another around the inner core. The two semi-cylindrical bundles may iron-cobalt.

In some embodiments, a method of manufacturing a magnetic core includes providing a plurality of magnetic strips each having a length longer than a width, coupling the plurality of magnetic strips along one length of each of the plurality of magnetic strips, and shaping the plurality of magnetic strips partially or fully around an inner circumference. Providing the plurality of magnetic strips may involve cutting each of the plurality of magnetic strips to be substantially identical to one another. Coupling the plurality of magnetic strips may involve gluing the plurality of magnetic strips together. Shaping the plurality of magnetic strips may involve forming the plurality of magnetic strips over a circumference of an inner tubing having an external circumference of the inner circumference. The method may further include inserting the plurality of magnetic strips shaped around the inner circumference into an external tubing comprising fiber-glass.

In some embodiments, a method of manufacturing a magnetic core includes providing a plurality of magnetic strips each having a length longer than a width, coupling the plurality of magnetic strips along one length of each of the plurality of magnetic strips, and shaping the plurality of magnetic strips partially or fully around an inner circumference. Coupling the plurality of magnetic strips along one length may involve compressing the plurality of magnetic strips together. Shaping the plurality of magnetic strips partially or fully around the inner circumference comprises forming two substantially half-cylindrical stack of the plurality of magnetic strips, where each of the two substantially half-cylindrical stack are configured to mate with one another around the inner circumference. The method may further involve cutting extra material off one or both of the two substantially half-cylindrical stacks to improve a fit between the two substantially half-cylindrical stacks. The method may further include impregnating the magnetic core with resin.

### BRIEF DESCRIPTION OF THE DRAWINGS

Various aspects of this disclosure may be better understood upon reading the following detailed description and upon reference to the drawings in which:

FIG. 1 is a schematic diagram of a system for measuring metal thickness of a casing using a downhole logging tool, in accordance with an embodiment with the present disclosure;

FIG. 2 is a schematic diagram of a cross-section of a logging tool used to measure metal thickness of a casing within multiple casings, in accordance with an embodiment of the present disclosure;

FIGS. 3A, 3B, and 3C are representations of a bundle of magnetic stacks formed over an inner tube and inserted in an external tube, in accordance with an embodiment of the present disclosure;

FIG. 4 is a system for cutting magnetic strips, in accordance with an embodiment of the present disclosure;

FIG. 5 is schematic diagram of a cross-sectional view of a magnetic core having multiple layers of bundled magnetic strips, in accordance with an embodiment of the present disclosure;

FIG. 6 is a schematic exploded diagram of a magnetic core having two semi-cylindrical components of stacked magnetic strips around an inner tube, in accordance with an embodiment of the present disclosure;

FIG. 7 includes a longitudinal and an axial cross sectional view of a semi-cylindrical component from FIG. 6, in accordance with an embodiment of the present disclosure;

FIGS. 8A and 8B are schematic views of machinery suitable for forming the semi-cylindrical components, in accordance with an embodiment of the present disclosure; and

FIG. 9 is a schematic drawing of a cross section of a semi-cylindrical component having extra material, in accordance with an embodiment of the present disclosure.

### DETAILED DESCRIPTION

One or more specific embodiments of the present disclosure will be described below. These described embodiments are only examples of the presently disclosed techniques. Additionally, in an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features.

Embodiments of the present disclosure relate to devices and methods for measuring metal thicknesses in one or more casings of a well (e.g., downwell tubular casings) using a measurement probe with a transmitter having a permeable core. The permeable core of the transmitter may generate a stronger magnetic field than a non-permeable core would generate. The stronger magnetic field may be used to determine the thicknesses of the casings even when multiple casings are located within one another in the well. By ascertaining the thicknesses of the casings, the measurement probe may identify material that has been lost during the usage of the casings owing to corrosion.

To determine material losses in the casings, the measurement probe may employ any suitable metal thickness testing, such as eddy current testing or remote field eddy current (RFEC) testing. In RFEC testing, the measurement probe may be inserted within the inner diameter of the inner most of the casings. The effectiveness of RFEC testing may depend at least partly on the strength of magnetic field, and the strength of the magnetic field may depend at least partly on the size of the measurement probe. The size of the measurement probe may depend on the logging tool in which it is installed, which itself may depend on the interior diameter of the innermost of the casings (e.g., approximately 2 inches to 36 inches). A greater magnetic field may be used to measure thicker and larger casings. In some embodiments, a greater magnetic field may be generated by increasing the field strength of the magnetic core. The embodiments of the present disclosure relate to techniques for amplifying or increasing the magnetic signals generated by the magnetic core of the electromagnetic logging tool.

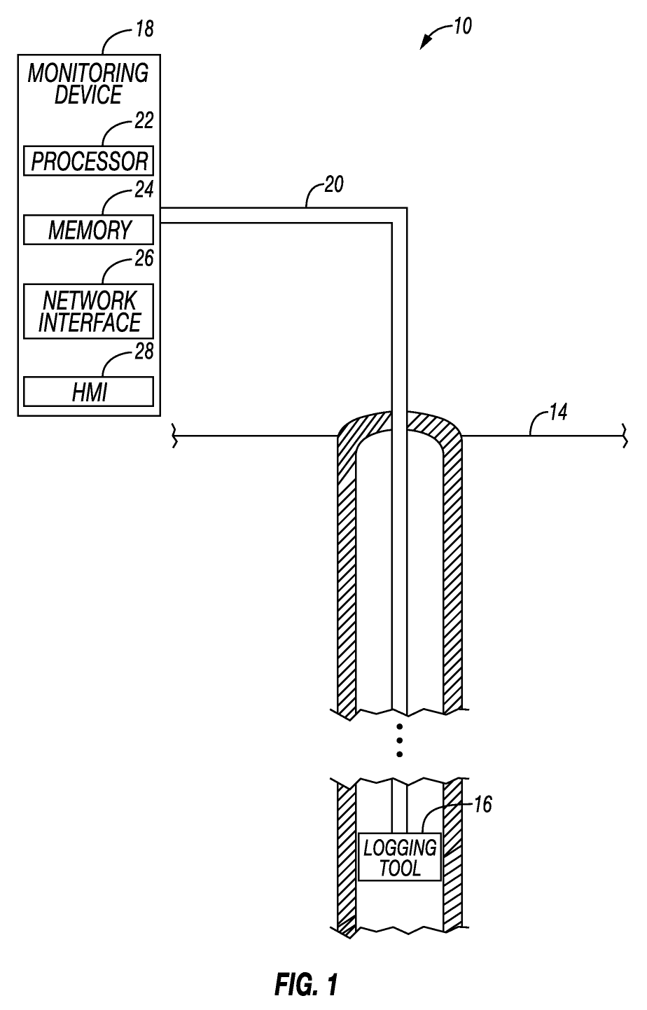

With the foregoing in mind, FIG. 1 is a block diagram depicting a system 10 that may be used to determine thickness (e.g., 0.1 inches to 4 inches) and/or defects due to corrosion of one or more casings 12. For example, an outer surface of the one or more casings 12 may be corroded by contact with soil and/or water. In some embodiments, the casings 12 may be measured while within the earth 14, water, and/or air. The system 10 includes a logging tool 16 that may be lowered into the one or more casings 12. As will be discussed further below, the logging tool 16 generates a magnetic field signal that interacts with the casings 12. The logging tool 16 is pumped with an AC current and emits the magnetic field signal. The magnetic field signal travels outwards from the logging tool 16 through and along the casings 12. The magnetic field signal from the logging tool 16 may therefore generate eddy currents in the casings 12 that produce corresponding returning magnetic field signals. The logging tool 16 may detect the returning magnetic field signals. In areas of metal loss in the casings 12, the returning magnetic field signal may arrive at the logging tool 16 with a faster travel time (e.g., less phase change) and/or greater signal strength (e.g., higher amplitude) than otherwise, owing to the reduced path through the one or more casings 12.

The logging tool 16 may be coupled to a monitoring device 18 via a communication link 20 that maintains connection between the logging tool 16 and the monitoring device 18 as the logging tool 16 traverses the length of the one or more casings 12. The monitoring device 18 may include a processor 22, a memory 24, a network interface 26, a human machine interface (HMI) 28, and/or other electronic components suitable for monitoring and/or analyzing measurements of the logging tool 16 and relaying that information to an appropriate destination such an end user and/or log.

In the monitoring device 18, the processor(s) 22 and/or other data processing circuitry may be operably coupled with the memory 24 to execute instructions. Such programs or instructions executed by the processor(s) 22 may be stored in any suitable article of manufacture that includes one or more tangible, computer-readable media at least collectively storing the instructions or routines, such as the memory 24. The memory 24 may include any suitable articles of manufacture for storing data and executable instructions, such as RAM, ROM, rewritable flash memory, hard drives, and optical discs. Also, programs (e.g., an operating system) encoded on such a computer program product may also include instructions that may be executed by the processor(s) 22. In some embodiments, the logging tool 16 may include one or more processors that perform the below-described processing.

The network interface 26 may include circuitry for communicating over one more networks. For example, the network interface 26 may include interfaces for a personal area network (PAN), such as a Bluetooth network, for a local area network (LAN), such as an 802.11x Wi-Fi network, and/or for a wide area network (WAN), such as a 3G or 4G cellular network.

The HMI 28 may include one or more input and/or output devices for enabling communication between the processor 22, the memory 24, the network interface 26, and one or more users. In some embodiments, the HMI 28 may include one or more input devices and one or more output devices. For example, in certain embodiments, the HMI 28 may include a display and/or a keyboard, a mouse, a touch pad, or other input devices suitable for receiving inputs from a user. In some embodiments, the HMI 28 may include a touch-screen liquid crystal display (LCD), for example, which may enable users to interact with a user interface of the monitoring device 18.

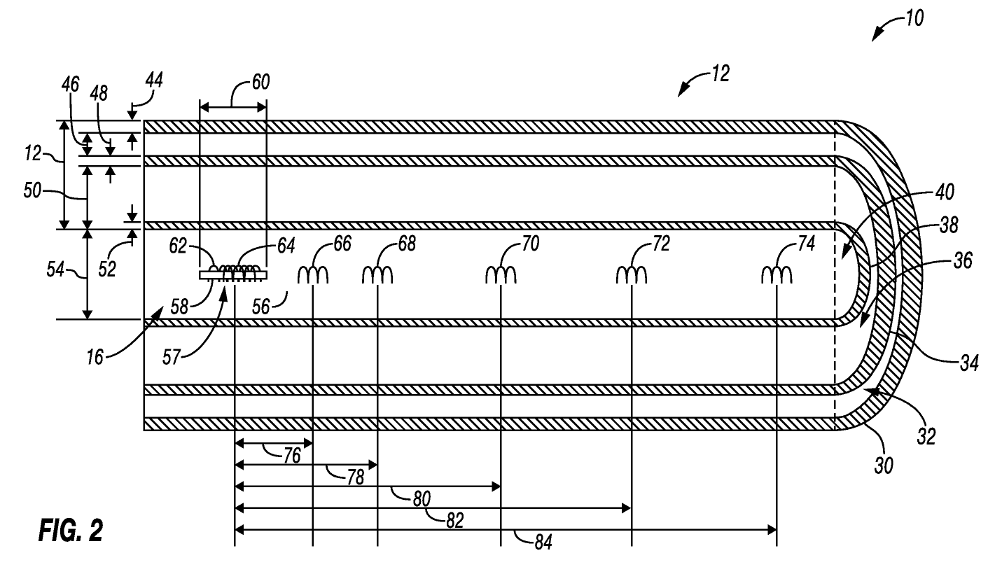

FIG. 2 depicts a cross-sectional view inside the one or more casings 22. The illustrated embodiment of the casing 22 includes a total thickness 42, an outer casing 44, an outer spacing 46, a middle casing 48, a middle spacing 50, and an inner casing 52. Although the illustrated embodiment illustrates three casings with a total thickness 42 including an outer casing 44, a middle casing 48, and an inner casing 52, other embodiments may include 1, 2, 4, 5, or more casings. In other words, the total thickness 42 is the sum of the thickness of the outer casing 44, the middle casing 48, and the inner casing 52. In some embodiments, the casings 12 may include at least one other casing that is non-concentric with the inner casing 54. The logging tool 16 traverses the casings 12 within an inner diameter 54 of the casings 12 located at the center of the casings 12. In certain embodiments, the logging tool 16 includes a housing 56 that encloses the logging tool 16 components. In some embodiments, the housing 56 may be a pressure-resistant housing. Within the housing 56, the logging tool 16 includes a transmitter 57 that includes a magnetic core 58 having a length 60. The magnetic core 38 may include a permeable transmitter core and/or a solenoid coil. In some embodiments, the magnetic core 58 may be formed from silicon steel (μ=3,000-20,000), ferrite materials (μ=300-2,000), mu metals (μ=10,000-50,000), or combinations thereof and may include one or more sheets or layers of materials. In some embodiments, magnetic core 58 may be configured to increase its magnetic field amplitude. For example, in some embodiments, the magnetic core 58 may components 62 and/or 64 which are composed of materials or shaped to increase the magnetic field generated by the tool (e.g., by about approximately 10-50 dB). The features of the magnetic core 58, in some embodiments, may also increase the filling factor of the core from about 70% to about 90%, thereby increasing the total magnetic flux of the core without saturation which may lower the magnetic field amplitude, generate higher order harmonics, and/or degrade measurement accuracy. By increasing the generated magnetic field, noise measured at the receiver windings (e.g., receivers 66, 68, 70, 72 and/or 74) generated by travel through the casings 12 may be relatively small in relation to the higher magnetic field field. Accordingly, a magnetic core 58 may enable logging metal thicknesses more quickly because the logging tool 16 may be moved through the casings 12 more rapidly due to the higher signal to noise ratio (SNR) achieved from the boosted field. This may reduce the time to log the metal thicknesses of the casings 12 accordingly. The magnetic core 58 makes a magnetic circuit, passing axially along the core 58, through an air gap between the core 58 and the metallic casing 12 and back in the reverse direction through the casing 12.

The logging tool 16 also may include one or more receivers (e.g., 66, 68, 70, 72, and/or 74). In the illustrated embodiment, the receivers 66, 68, 70, 72, and 74 are each located in a line along the logging tool 16. Each receiver 66, 68, 70, 72, and 74 is located some distance away from the transmitter 57. For example, the receiver 66 may be located a distance 76 from the transmitter 57, the receiver 68 may be located a distance 78 from the transmitter 57, the receiver 70 may be located a distance 80, the receiver 72 may located a distance 82 from the transmitter 57, and the receiver 74 may be located a distance 84 from the transmitter 57. In certain embodiments, each distance 78, 80, 82, and 84 may be a multiple of the distance 76. For example, the distance 78 may be twice the distance 76, and distances 80, 82, and 84 may respectively be three, four, and five times the distance 78. Furthermore, in some embodiments, the distance 76 may be greater than or equal to the length 60. In certain embodiments, the receivers 66, 68, 70, 72, or 74 may be located at distances of between 7 inches or less to 90 inches or more from the transmitter 57. The receivers 66, 68, 70, 72, or 74 may detect the strength and/or phase of the returning magnetic field from the casing 12. These detected values may then be used to determine a thickness of the casing 12 using any suitable RFT analyses. Although the receivers 66, 68, 70, 72, or 74 are illustrated as axially located receivers, in some embodiments, at least some of the receivers 66, 68, 70, 72, and 74 may be located azimuthally adjacent to an inner wall of the casing. In certain embodiments, at least some of the receivers 66, 68, 70, 72, and 74 may have a radial sensitivity (e.g., saddle coils, Hall-effect sensor, giant magneto-resistive sensor) configured to detect defects or transverse cracks in the casing 12.

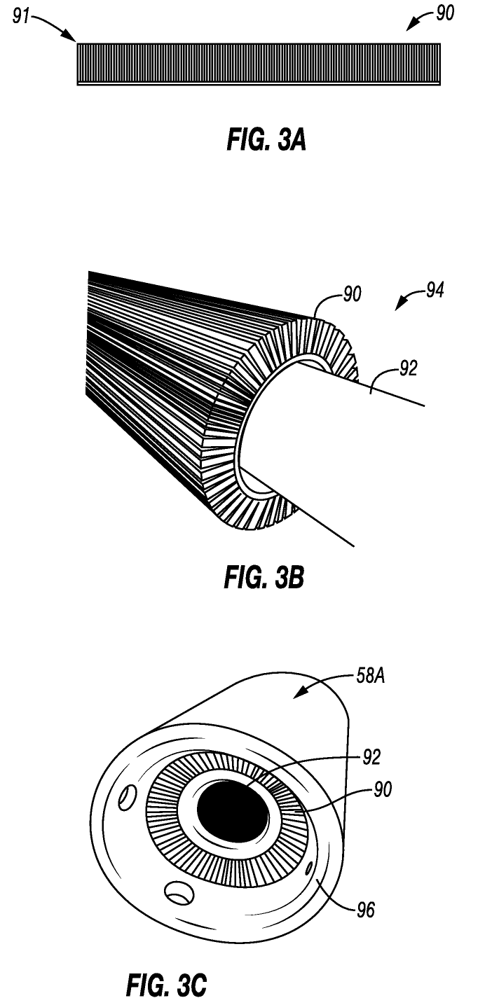

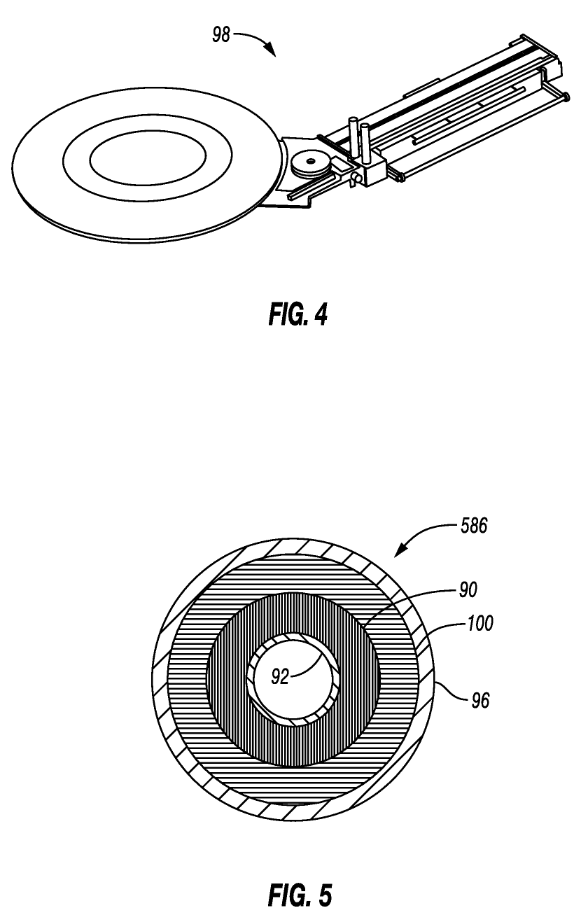

One or more embodiments of a magnetic core 58 include a core having high magnetic permeability and relatively high metal density which contribute to generating a high amplitude magnetic field while minimizing saturation in the material. The magnetic core 58 may include multiple layers, including an internal tubing which may be used as a support during the assembly process and may function as a cable path in operation. The magnetic core 58 may also include the magnetic core itself, as well as an external tubing having external grooves receiving the coil. All parts of the magnetic core 58 may be coupled together (e.g., using glue, in some embodiments). In some embodiments, the magnetic core 58 may include silicon-iron strips. The silicon-iron strips may be assembled in a crown arrangement, or in an arrangement having high metal density. The silicon strips 91 may be glued in a bundle 90, as in FIG. 3A. The silicon strips 91 may have suitable magnetic properties and be cut to length. In some embodiments, the strips may be cut with a strip cutting tool. A reel of silicon-iron or other suitable magnetic material may be guided in a narrow channel until it reaches a limit stop at the end of the channel. The strip may be cut to length and pushed into a drawer. Once the drawer is filled, the strips may be pressed tightly together, and a layer of flexible glue may be applied on the back. The thickness of the glue layer may be controlled by a gauge. The drawer and the strips may be placed in an oven for curing. One example of a system 98 for cutting the magnetic strips is provided in FIG. 4.

Once the glue is cured, the magnetic bundle 90 may be wrapped around the outer circumference of the inner tubing 92, as shown in FIG. 3B. The assembly 94 including the bundle 90 wrapped around the inner tubing 92 may be inserted in the inner circumference of the external tubing 96. The external tubing 96 may include fiber-glass material or another suitable material. In some embodiments, coils may be mounted before the insertion of the assembly 94 into the external tubing 96. In some embodiments, the final assembly may be placed in an autoclave with a tooling maintaining the parts in place. After vacuuming the autoclave, the glue may be injected and pressure may be applied to fill up all voids. Pressure is relieved and glue in excess may be removed, and the autoclave may cure the final assembly. An embodiment of a magnetic core 58a having a bundle 90 of silicon-iron strips 91 arranged around an inner tubing 92 and inside an external tubing 96 is shown in FIG. 3C. Due to the configuration of the magnetic core 58a, the total magnetic flux generated by the coil is distributed on the cumulated cross-section of the strips. As the total cross section of the magnetic core increases, the magnetic flux is balanced over a wider area, thereby limiting the impact of magnetic saturation of the material.

In some embodiments, the magnetic core 58 may include multiple layers. For example, as shown in the cross-sectional view in FIG. 5, the magnetic core 58b has two concentric layers 90 and 100 of magnetic strips bundled and wrapped over the inner tubing 92 and inside the external tubing 96. The additional layer 100 may increase bending stiffness against lateral shocks.

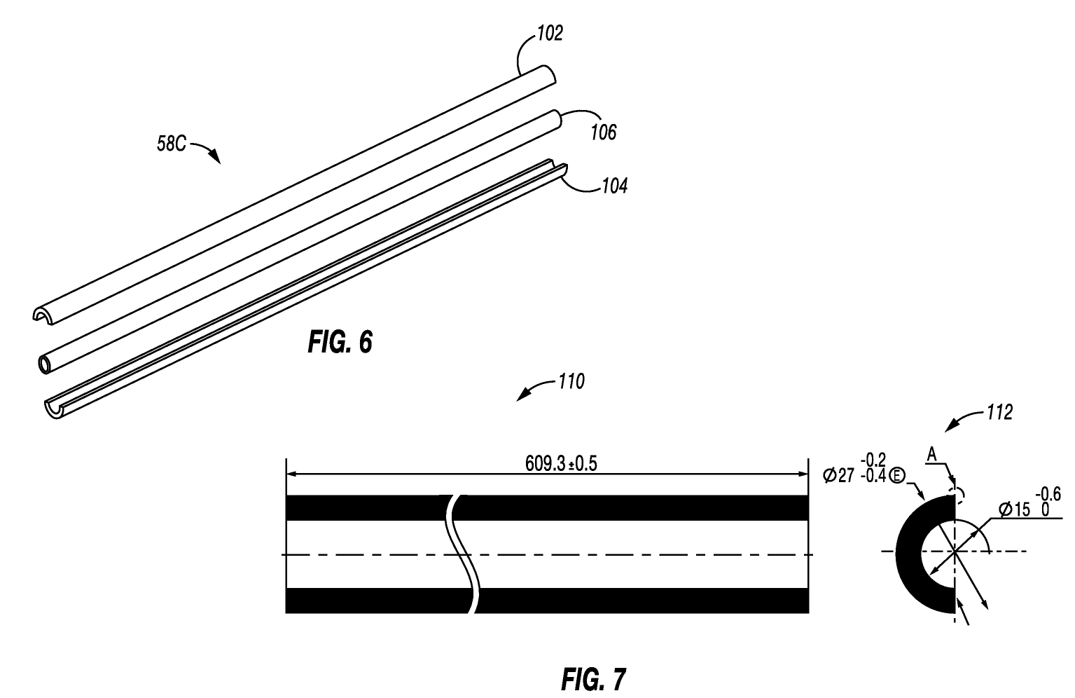

In one or more embodiment, the magnetic core 58 may include iron-cobalt and may have an improved filling factor from approximately 70% to 90% and may have an increased total magnetic flux without saturation. In some embodiments, and as depicted in the schematic exploded drawing in FIG. 6, the magnetic core 58c may have two or more semi-cylindrical parts 102 and 104 mating with each other, where each part may be manufactured separately by stacking and shaping thin iron-cobalt sheets. The parts 102 and 104 may then be assembled around an inner tube 106 which accommodates the electrical harness disposed through the tool. The inner tube 106 may include fiber-glass or another suitable material. The azimuthal discontinuity between the magnetic sheets may be important to prevent generation of eddy currents by the axial magnetic field.

In some embodiments, the parts 102 and 104 may be similar to a half-pipe shape and may be made of stacked iron-cobalt sheets, each one being approximately 0.05-0.2 mm thick (e.g., approximately 0.1 mm thick in one embodiment). FIG. 7 is a schematic of longitudinal 110 and axial 112 cross sections of a part 102 or 104 which may be composed of several strips of iron-cobalt sheets (e.g., 50 to 70 sheets) stacked into the standard C-shape as shown in the axial cross section 112. The sheets may be on the scale of 10 cm-100 cm long. In some embodiments, C-shaped, oblong, or toroidal shaped cores, or cores of other shapes may be suitable.

Magnetic cores may be built by suitable manufacturing processes. One conventional manufacturing process involves rolling a magnetic metal sheet (e.g., iron-cobalt in some embodiments) around an inner hub having a suitable shape (e.g., cylindrical, oblong, etc.). Such a technique may limit the maximum sheet width, as wider sheets need larger force to keep the sheet taught. Another conventional manufacturing process includes stacking pre-cut magnetic sheets. However, piling up hollow disks may result in strong eddy currents in the core, thus degrading the magnetic field amplitude.

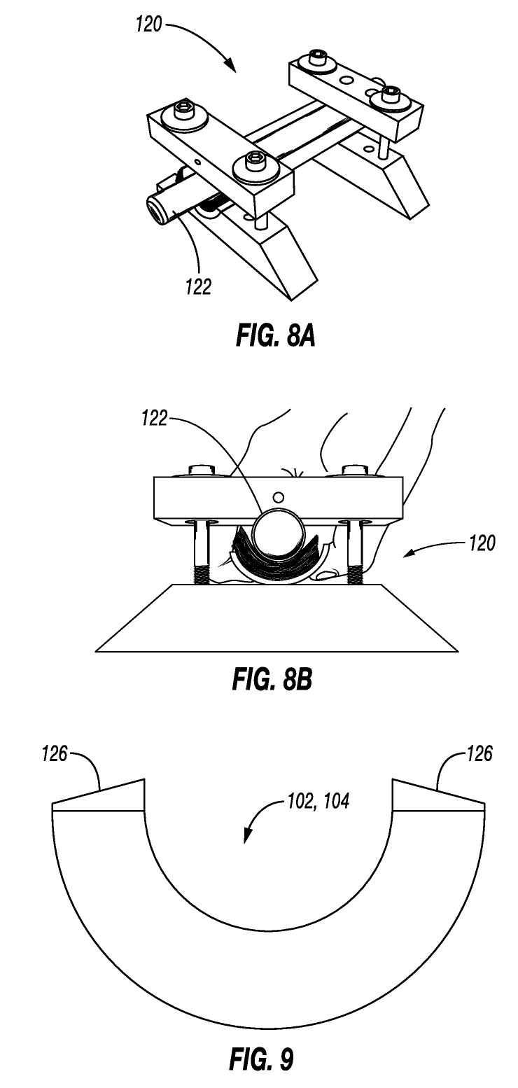

In one or more embodiments of the present techniques, a manufacturing process for building the magnetic cores includes stacking iron-cobalt metal sheets to reach a certain core thickness. The sheets may be approximately 61 cm (24 inches) long and may have a width larger than half the outer perimeter of the core shape. The stacked sheets may be deformed together with a hub, as shown in FIG. 8A and FIG. 8B. The hub 120 may compress the iron-cobalt sheest positioned in a die. The hub may include a cylindrical bar 122 that has the diameter similar to the final shape of the magnetic core 58. The die inner diameter may be the outer diameter of the final part.

In one embodiment, a newly formed semi-cylindrical part 102 or 104 may be kept in the die while it is heat treated. The part 102 or 104 may then be impregnated with resin and polymerized. The part 102 or 104 may then be cut on both sides to generate a true half cylindrical shape, as represented in FIG. 9, where the extra material 126 may be trimmed from the part 102 or 104. The magnetic core 58 may be assembled by mating two half-parts with each other on an inner tube, and the assembled components may then be integrated in a transmitter assembly and impregnated again with resin to fasten all parts together.

In accordance with the present techniques, the manufacturing process may be used for any core, including those not suitable for manufacture using conventional techniques due to its larger length or shape.

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

What is claimed is:

1. An apparatus for measuring casing thickness comprising:
a magnetic core comprising:
an inner core having a core length; and
one or more bundles comprising stacked magnetic strips arranged over the core length of the inner core.

2. The apparatus of claim 1, wherein the magnetic core further comprises an external layer substantially surrounding the one or more bundles.

3. The apparatus of claim 1, wherein the one or more bundles comprises a bundle of silicon-iron strips coupled together on one side and flexibly formed over the inner core.

4. The apparatus of claim 3, wherein the one or more bundles comprises a first bundle formed over and around the inner core and a second bundle formed over and around the first bundle.

5. The apparatus of claim 1, wherein the one or more bundles comprises two semi-cylindrical bundles each comprising the stacked magnetic strips, wherein the two semi-cylindrical bundles are configured to mate with one another around the inner core.

6. The apparatus of claim 5, the two semi-cylindrical bundles comprises iron-cobalt.

7. A method of manufacturing a magnetic core, the method comprising:
providing a plurality of magnetic strips each having a length longer than a width;
coupling the plurality of magnetic strips along one length of each of the plurality of magnetic strips; and
shaping the plurality of magnetic strips partially or fully around an inner circumference.

8. The method of claim 7, wherein providing the plurality of magnetic strips comprises cutting each of the plurality of magnetic strips to be substantially identical to one another.

9. The method of claim 7, wherein coupling the plurality of magnetic strips comprises gluing the plurality of magnetic strips together.

10. The method of claim 7, wherein shaping the plurality of magnetic strips comprises forming the plurality of magnetic strips over a circumference of an inner tubing having an external circumference of the inner circumference.

11. The method of claim 7, further comprising inserting the plurality of magnetic strips shaped around the inner circumference into an external tubing comprising fiber-glass.

12. The method of claim 7, wherein coupling the plurality of magnetic strips along one length comprises compressing the plurality of magnetic strips together.

13. The method of claim 7, wherein shaping the plurality of magnetic strips partially or fully around the inner circumference comprises forming two substantially half-cylindrical stack of the plurality of magnetic strips, wherein each of the two substantially half-cylindrical stack are configured to mate with one another around the inner circumference

14. The method of claim 7, further comprising cutting extra material off one or both of the two substantially half-cylindrical stacks to improve a fit between the two substantially half-cylindrical stacks.

15. The method of claim 7, further comprising impregnating the magnetic core with resin.
